(19) United States
(12) Patent Application Publication
(10) Pub. No.: US 2018/0129154 A1
(43) Pub. Date: May 10, 2018

(54) IMAGE FORMING APPARATUS

(71) Applicant: CANON KABUSHIKI KAISHA, Tokyo (JP)

(72) Inventors: Hiroshi Tomii, Kashiwa-shi (JP); Taichi Takemura, Abiko-shi (JP); Nobuhiko Zaima, Kashiwa-shi (JP)

(21) Appl. No.: 15/798,930

(22) Filed: Oct. 31, 2017

(30) Foreign Application Priority Data
Nov. 10, 2016 (JP) 2016-219920

(51) Int. Cl. G03G 15/00

(52) U.S. Cl. CPC G03G 15/5054

(57) ABSTRACT

Provided is an image forming apparatus capable of reducing the time required for calibration of an image forming condition. The image forming apparatus includes image forming portions configured to form images onto photosensitive drums, an intermediate transfer member onto which the images are sequentially transferred from the photosensitive drums, and a density detection sensor. The density detection sensor starts measuring a base surface density of the intermediate transfer member before a measurement image is formed on the intermediate transfer member. When a measurement start position of the base surface density reaches a transfer position of an image of an image forming portion located at the most upstream position in a rotation direction of the intermediate transfer member, the image forming apparatus causes the image forming portion to start forming the measurement image.

### BACKGROUND OF THE INVENTION

### Field of the Invention

The present invention relates to an electrophotographic image forming apparatus.

### Description of the Related Art

In an electrophotographic image forming apparatus, an image density of a formed image easily varies due to a usage environment, the number of printed sheets, and other factors. In a color image forming apparatus configured to perform color printing by superimposing images of a plurality of colors on one another, variation in image density of each color causes variation in color balance (color hue), and thus an image quality is reduced. Therefore, the image forming apparatus performs density correction for suppressing the variation in image density.

When performing the density correction, the image forming apparatus forms a toner image (measurement image) for detecting the image density onto an image bearing member, for example, a photosensitive member or an intermediate transfer member. The image forming apparatus detects the image density of the measurement image by an optical sensor, and corrects the density based on the detection result, to thereby stabilize the image quality. The density correction is performed through, for example, calibration of an image forming condition. Examples of the image forming condition include an exposure amount, a developing bias, and a γ correction table. The exposure amount refers to an amount of laser light to be radiated to the image bearing member by an exposing device when an image is formed onto the image bearing member. The developing bias refers to a bias voltage to be applied to a developing device when an electrostatic latent image, which is formed by radiating laser light to the image bearing member, is developed. The developing bias is used to adjust an amount of developer used when the electrostatic latent image is developed. The γ correction table represents a relationship of the image density (output density) of the actually formed image with respect to the image density (input density) of image data representing the image to be formed. The output density is adjusted by the calibration of the image forming condition.

As types of the optical sensor used during density correction, there are a type in which the image density is detected by diffusely reflected light and another type in which the image density is detected by specularly reflected light. A surface (base surface) of the intermediate transfer member on which the image is to be formed generally has a black color or a dark gray color because carbon black is dispersed thereon. Therefore, the optical sensor of a type in which the image density is detected by the diffusely reflected light has difficulty in detecting an image density of a black measurement image formed on the base surface of the intermediate transfer member. The optical sensor of a type in which the image density is detected by the specularly reflected light detects the amount of light reflected from the base surface of the intermediate transfer member, and hence is capable of detecting the image density of the black measurement image. Therefore, density correction is generally performed with use of the optical sensor of the type in which the image density is detected by the specularly reflected light.

During the calibration of the image forming condition, the image forming apparatus detects the density of the base surface (base surface density) of the intermediate transfer member at a position at which the measurement image is to be formed at a stage before the measurement image is formed. This operation is performed because abrasion and contamination of the intermediate transfer member may cause change in base surface density of the intermediate transfer member, and this change may affect the image density of the measurement image. In the related-art image forming apparatus, a position detection member is provided at a predetermined position of the intermediate transfer member, and the base surface density is detected in accordance with the position of the position detection member. The intermediate transfer member is rotating. The image forming apparatus starts forming the measurement image when, after the base surface density is detected, the intermediate transfer member is rotated one revolution and thus the position detection member is detected again. With this, the image forming apparatus is capable of detecting the base surface density of the intermediate transfer member and the image density of the measurement image at the same position of the intermediate transfer member, and thus the calibration of the image forming condition can be performed with high accuracy.

Incidentally, during the calibration of the image forming condition, the image forming apparatus is required to rotate the intermediate transfer member one revolution before the measurement image is formed, to thereby acquire the base surface density. Therefore, a standby time is required before the formation of the measurement image during the calibration of the image forming condition. In Japanese Patent Application Laid-open No. 2013-178359, there is disclosed an image forming apparatus configured to acquire the latest length of one turn of the intermediate transfer member in advance, and to acquire the base surface density for one turn of the intermediate transfer member as soon as the calibration of the image forming condition is started. In this image forming apparatus, the formation of the measurement image is started immediately after the acquisition of the base surface density of the intermediate transfer member for one turn is completed.

However, even in the image forming apparatus of Japanese Patent Application Laid-open No. 2013-178359, the formation of the measurement image is not started unless the intermediate transfer member rotates one revolution, and thus a standby time is required before the start of the formation of the measurement image. Therefore, a long time is required for the calibration of the image forming condition. The present invention has been made in view of the above-mentioned problems, and has an object to provide an image forming apparatus capable of reducing the time required for calibration of an image forming condition.

### SUMMARY OF THE INVENTION

An image forming apparatus according to the present disclosure includes: an image forming unit configured to form an image; an intermediate transfer member configured to rotate; a transfer unit configured to transfer a measurement image formed by the image forming unit onto the intermediate transfer member; a measurement unit configured to measure the measurement image transferred onto the intermediate transfer member; and a controller configured to: control the image forming unit to form the measurement image; control the transfer unit to transfer the measurement image onto the intermediate transfer member; control the measurement unit to measure the measurement image; and control an image forming condition based on measurement data corresponding to a measurement result of the measurement image measured by the measurement unit and profile data relating to the intermediate transfer member, wherein the controller controls, while the intermediate transfer member rotates, the measurement unit to measure the intermediate transfer member, and generates the profile data based on a measurement result of the intermediate transfer member for single turn, and wherein the controller controls the image forming unit to start forming the measurement image before the measurement of the intermediate transfer member for single turn is ended.

Further features of the present invention will become apparent from the following description of exemplary embodiments (with reference to the attached drawings).

### BRIEF DESCRIPTION OF THE DRAWINGS

FIG. 1 is a hardware configuration diagram of an image forming apparatus.

FIG. 2 is an explanatory diagram of software modules of the image forming apparatus.

FIG. 3 is a functional block diagram of an image processing unit.

FIG. 4 is a hardware configuration diagram of a printer engine.

FIG. 5 is a configuration diagram of an image forming part of the printer engine.

FIG. 6 is a configuration diagram of a density detection sensor.

FIG. 7 is a graph for showing output values of light receiving portions with respect to an image density of a measurement image.

FIG. 8 is an explanatory graph of a density conversion table.

FIG. 9 is a flow chart for illustrating processing of detecting an image density of a measurement image of the related art.

FIG. 10 is an explanatory diagram of the processing of FIG. 9.

FIG. 11 is a flow chart for illustrating processing of detecting an image density of a measurement image in an embodiment of the present invention.

FIG. 12 is a timing chart of the processing of detecting the image density of the measurement image.

FIG. 13 is a table of the time required for each step.

FIG. 14 is a timing chart of mode switching between a constant current mode and a constant voltage mode.

FIG. 15 is a timing chart of the processing of detecting the image density of the measurement image.

FIG. 16 is a table of the time required for each step.

### DESCRIPTION OF THE EMBODIMENTS

Embodiments of the present invention are described below in detail with reference to the drawings. In the following, description is given of an example in which the present invention is applied to an electrophotographic color image forming apparatus including a plurality of photosensitive drums, but the present invention is not limited thereto. Needless to say, the present invention is applicable to electrophotographic copying machines employing various systems, printers, and monochromatic-color systems.

### First Embodiment

### Configuration

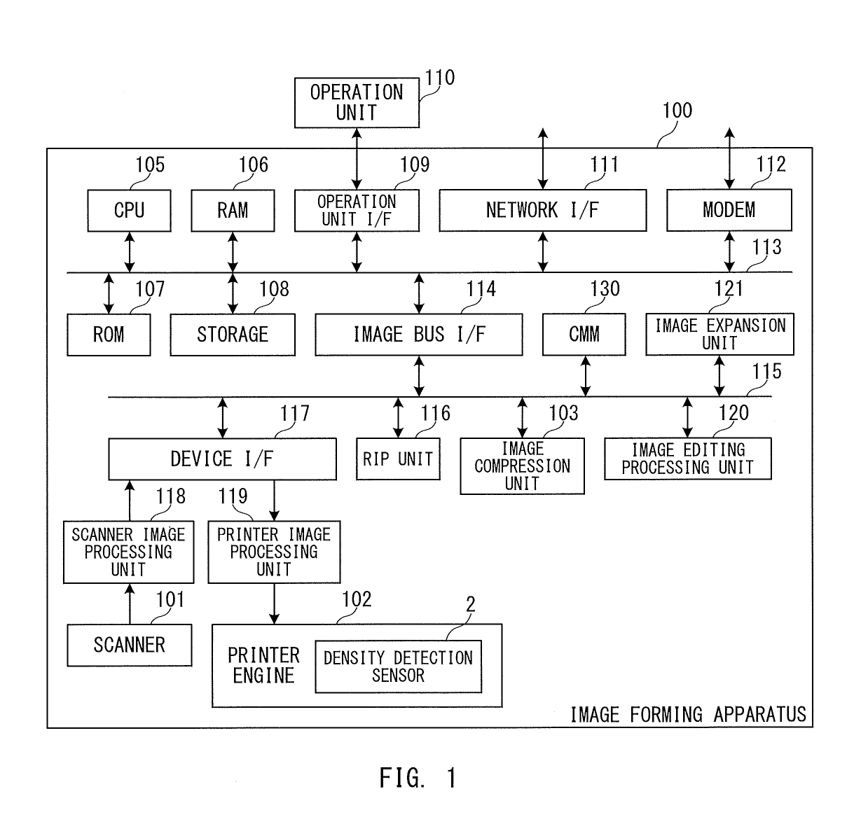

FIG. 1 is a hardware configuration diagram of an image forming apparatus according to a first embodiment of the present invention. An image forming apparatus 100 includes a scanner 101 configured to read an image from, for example, an original to generate image data, and a printer engine 102 configured to perform image forming processing to form an image on a recording medium, for example, a sheet. The scanner 101 is controlled by a scanner image processing unit 118 to perform operations such as image reading and image data generation. The printer engine 102 is controlled by a printer image processing unit 119 to perform an operation for forming an image.

Further, the image forming apparatus 100 is connected to an operation unit 110. The operation unit 110 is a user interface including an input button, a numeric keypad, a display, and a touch panel. The image forming apparatus 100 receives an instruction from a user through the operation unit 110, and provides information to the user by the operation unit 110.

The image forming apparatus 100 includes a system bus 113 and an image bus 115. The system bus 113 has a configuration for controlling the entire operation of the image forming apparatus 100. The image bus 115 has a configuration for controlling the operation of the scanner 101 and the operation of the printer engine 102. The system bus 113 and the image bus 115 are connected to each other by an image bus interface (I/F) 114 so as to enable communication therebetween. The image bus I/F 114 is an interface configured to connect between the system bus 113 and the image bus 115 for transmitting the image data at high speed, and is a bus bridge configured to convert data structure.

A central processing unit (CPU) 105, a random access memory (RAM) 106, a read only memory (ROM) 107, and a storage 108 are also connected to the system bus 113. The CPU 105 reads out a computer program from at least one of the ROM 107 or the storage 108, and executes the computer program with use of the RAM 106 serving as a work area, to thereby control the operation of the image forming apparatus 100. The storage 108 is a large-capacity storage device, for example, a hard disk drive (HDD) or a solid state drive (SSD).

The system bus 113 is further connected to an operation unit I/F 109, a network I/F 111, and a modem 112. The operation unit I/F 109 is an interface for the operation unit 110. The operation unit I/F 109 is configured to receive input, for example, the instruction from the user, from the operation unit 110 to transmit the input to the CPU 105. Further, the operation unit I/F 109 is configured to cause the display of the operation unit 110 to display an image, for example, an operation screen based on an instruction from the CPU 105. The network I/F 111 is, for example, a network interface card (NIC), and is controlled by the CPU 105 to control communication to/from an external device via a network, for example, a local area network (LAN). The modem 112 is controlled by the CPU 105 to control communication to an external device via a public line. The image data to be used for image formation may be acquired from an external device via the network I/F 111 or the modem 112.

The image bus 115 is connected to a device I/F 117, a raster image processor (RIP) unit 116, an image compression unit 103, an image editing processing unit 120, an image expansion unit 121, and a color management module (CMM) 130. The device I/F 117 is connected to the scanner image processing unit 118 and the printer image processing unit 119, and is configured to perform conversion between a synchronous system and an asynchronous system of the image data. The device I/F 117 is configured to transmit the instruction from the CPU 105 to the scanner image processing unit 118 and the printer image processing unit 119. In this manner, the scanner image processing unit 118 controls the operation of the scanner 101, and the printer image processing unit 119 controls the operation of the printer engine 102. The device I/F 117 is configured to acquire the image data from the scanner 101 via the scanner image processing unit 118, and to transmit the image data subjected to image processing to the printer engine 102 via the printer image processing unit 119.

The RIP unit 116 is configured to develop a page description language (PDL) code to the image data. The PDL code is received from an external device by the network I/F 111. The scanner image processing unit 118 is configured to subject the image data acquired from the scanner 101 to various types of processing such as correction and editing. The image editing processing unit 120 is configured to perform various types of image processing such as rotation, color processing, binary conversion, and multi-value conversion of the image data. The image compression unit 103 is configured to encode the image data processed by the RIP unit 116, the scanner image processing unit 118, and the image editing processing unit 120 with use of a predetermined compression system, and to store the encoded image data to the storage 108.

The image expansion unit 121 decodes and expands the compressed image data stored in the storage 108. The decoded image data is subjected to image processing by the image editing processing unit 120 and the printer image processing unit 119 as necessary, and is transmitted to the printer engine 102. The printer image processing unit 119 is configured to subject the image data to be used for image formation to image processing such as γ correction or halftone processing depending on the printer engine 102. Further, the printer image processing unit 119 is configured to perform calibration of an image forming condition, which is described later. Therefore, the printer image processing unit 119 is configured to acquire detection results from a density detection sensor 2 included in the printer engine 102. The density detection sensor 2 is described later.

The CMM 130 is a dedicated hardware module configured to subject the image data to color conversion processing (also referred to as color space conversion processing). The CMM 130 performs the color conversion processing to convert color image data expressed by a color space dependent on the apparatus into a color space independent of the apparatus, to thereby correct the color reproducibility of the scanner 101 or the printer engine 102.

### Software Modules

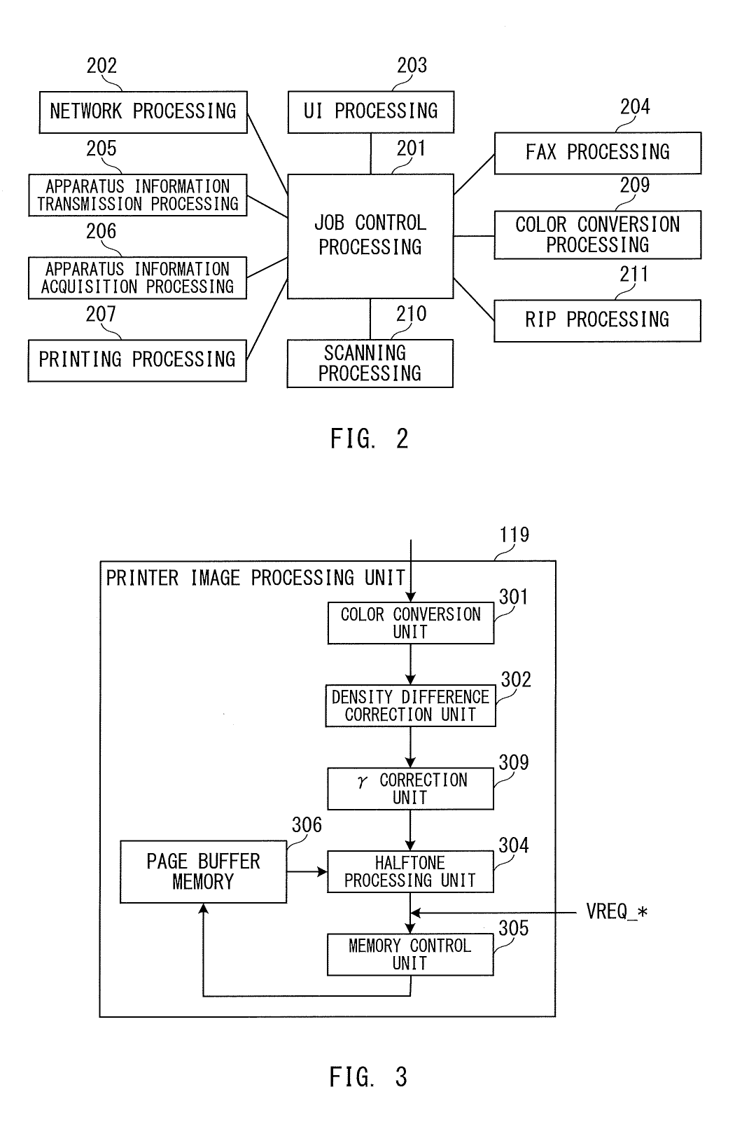

FIG. 2 is an explanatory diagram of software modules of the image forming apparatus 100. The software modules are implemented by the CPU 105 executing the computer program. Job control processing 201 generally controls each software module to control jobs such as copying, printing, scanning, and facsimile (FAX) communication, which are performed by the image forming apparatus 100. The software modules to be controlled are network processing 202, user interface (UI) processing 203, FAX processing 204, apparatus information transmission processing 205, apparatus information acquisition processing 206, printing processing 207, color conversion processing 209, scanning processing 210, and RIP processing 211.

The network processing 202 is a software module configured to mainly control communication to/from an external device via the network I/F 111. The UI processing 203 is a software module configured to mainly control communication to/from the operation unit 110 via the operation unit I/F 109. The FAX processing 204 is a software module configured to perform facsimile communication via the modem 112.

The apparatus information transmission processing 205 is a software module configured to transmit apparatus information to a predetermined external device by the network processing 202 based on the instruction from the job control processing 201. The apparatus information includes information representing the abilities and the characteristics of the image forming apparatus 100, such as the type (color/monochrome) of the printer engine 102, the resolution of the printer engine 102, the printing speed of the printer engine 102, the processing time of the color conversion processing 209, and the output profile. The apparatus information acquisition processing 206 is a software module configured to transmit an apparatus information acquisition request to a predetermined external apparatus by the network processing 202 based on the instruction from the job control processing 201.

The printing processing 207 is a software module configured to control the image editing processing unit 120, the printer image processing unit 119, and the printer engine 102 based on the instruction from the job control processing 201, to thereby perform image forming processing. The printing processing 207 acquires, from the job control processing 201, image data, image information (for example, image data size, color mode, and resolution), layout information (for example, offset, expansion/reduction, and imposition), and output sheet information (for example, size and printing direction). The printing processing 207 subjects the image data to image processing by the image compression unit 103, the image expansion unit 121, the image editing processing unit 120, and the printer image processing unit 119. The printing processing 207 controls the printer engine 102 based on the image data subjected to image processing, to thereby form an image on a designated recording medium.

The color conversion processing 209 subjects the image data to color conversion processing based on the instruction from the job control processing 201, to thereby transmit the image data subjected to color conversion processing to the job control processing 201.

The scanning processing 210 controls the scanner 101 and the scanner image processing unit 118 based on the instruction from the job control processing 201, to thereby cause the scanner 101 to read an image from the original. The scanning processing 210 acquires the image data that is digital data representing the image of the original from the scanner 101 to transmit the image data to the job control processing 201. The scanning processing 210 subjects the image data to image processing such as image compression by the scanner image processing unit 118, and then transmits the image data subjected to the image processing to the job control processing 201.

The RIP processing 211 performs PDL interpretation of (interprets) the image data based on the instruction from the job control processing 201, and controls the RIP unit 116 to perform rendering, to thereby develop the image data to a bitmap image.

With the above-mentioned configuration, the image forming apparatus 100 receives a print job from the operation unit 110 or the external device to form an image that is based on the image data onto a recording medium. When an image is to be formed, the printer image processing unit 119 subjects the image data to various types of processing.

### Image Data Processing

The PDL received from an external device is input to the RIP unit 116 via the image bus I/F 114 from the network I/F 111. The RIP unit 116 interprets the acquired PDL to convert the PDL into processable code data. The RIP unit 116 executes rendering of the image data based on the code data obtained by conversion. Page data (image data of each page) subjected to rendering by the RIP unit 116 is compressed by the image compression unit 103 and is sequentially stored in the storage 108.

The page data stored and compressed in the storage 108 is readout in a printing operation performed in accordance with the instruction from the job control processing 201, and is expanded by the image expansion unit 121. The image data of each page expanded by the image expansion unit 121 is input to the printer image processing unit 119 via the device I/F 117.

FIG. 3 is a functional block diagram of the printer image processing unit 119. The printer image processing unit 119 functions as a color conversion unit 301, a density difference correction unit 302, a γ correction unit 309, a halftone processing unit 304, a page buffer memory 306, and a memory control unit 305.

The color conversion unit 301 converts the image data from a brightness value (for example, RGB value or YUV value) into a density value (for example, CMYK value). The color conversion unit 301 converts the input image data into a color space corresponding to color components that can be printed by the printer engine 102.

The density difference correction unit 302 converts the image data converted into the density value in the color conversion unit 301 into a signal value whose density difference in the same page is corrected. The density difference correction unit 302 multiplies a one-dimensional table (γ correction table), which represents the relationship of the image density (output density) of the actually formed image with respect to the image density (input density) of the image data, by a difference correction coefficient for performing difference correction in accordance with the position in the page.

The γ correction unit 309 includes the γ correction table. The γ correction unit 309 subjects a signal value for reproducing, by the printer engine 102, the density value of the image data subjected to density difference correction to γ correction conversion. The γ correction table is a conversion table formed in advance based on the γ characteristics of the printer engine 102, and may be formed by known grayscale control or the like. The halftone processing unit 304 subjects the image data corrected by the γ correction unit 309 to halftone processing, to thereby generate the image data in which each color component of one pixel is represented by a binary value (1 bit). The halftone processing is performed by, for example, dithering or error diffusion. The halftone processing unit 304 temporarily stores the generated binary image data (video data) in the page buffer memory 306 divided for each color component of each pixel in the image data via the memory control unit 305.

The printer image processing unit 119 acquires a video data request signal corresponding to each color component from the printer engine 102, and reads out the video data (color component data) of the requested color component from the page buffer memory 306 to transmit the video data to the printer engine 102. The video data request signal is represented by VREQ_Y (yellow), VREQ_M (magenta), VREQ_C (cyan), or VREQ_K (black) with respect to each color component. The reason why the video data is requested for each color is that the exposure timing of each photosensitive drum differs depending on the arrangement of each photosensitive drum corresponding to each color component in the printer engine 102, and the timing to read out the data of each color component also differs.

### Printer Engine

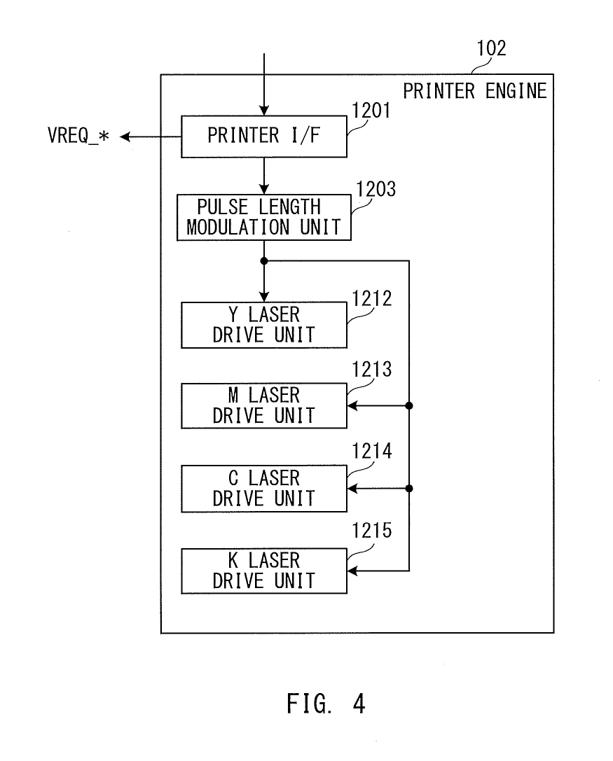

The operation of the printer engine is described. FIG. 4 is a hardware configuration diagram of the printer engine 102. The printer engine 102 includes a printer I/F 1201, a pulse length modulation unit 1203, a yellow (Y) laser drive unit 1212, a magenta (M) laser drive unit 1213, a cyan (C) laser drive unit 1214, and a black (K) laser drive unit 1215.

The printer I/F 1201 is an interface between the printer engine 102 and the printer image processing unit 119. The printer I/F 1201 is configured to receive the color component data that is sequentially transmitted from the printer image processing unit 119. Further, when the printer engine 102 becomes ready to perform the printing operation, the printer I/F 1201 outputs VREQ_* (“*” represents any one of Y, M, C, and K), which is the video data request signal of each color component.

The pulse length modulation unit 1203 is configured to acquire the color component data from the printer I/F 1201 to generate a drive signal that is a pulse signal for driving the laser drive unit of each color based on the color component data. The Y laser drive unit 1212, the M laser drive unit 1213, the C laser drive unit 1214, and the K laser drive unit 1215 are configured to acquire the drive signals from the pulse length modulation unit 1203 to emit light based on the pulse widths of the drive signals.

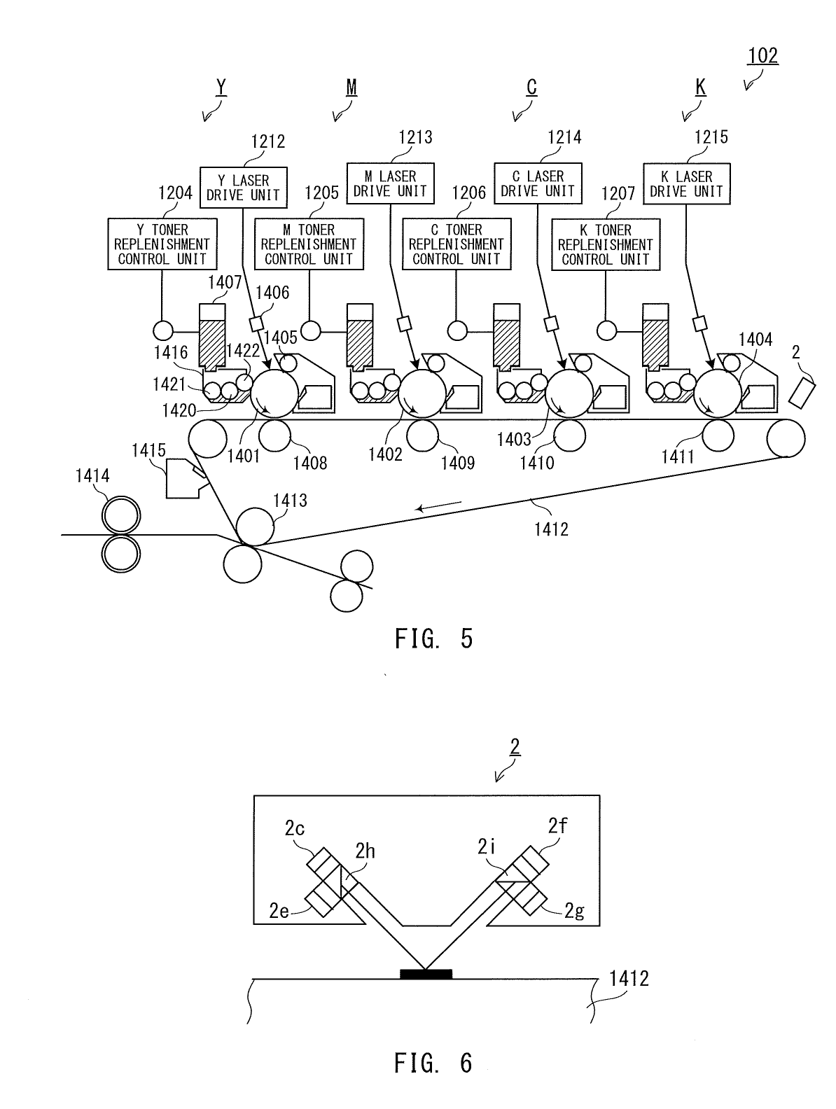

FIG. 5 is a configuration diagram of an image forming part of the printer engine 102. The printer engine 102 is of a tandem engine type including a plurality of image forming units (also referred to as image former). The printer engine 102 of the first embodiment includes a yellow (Y) image forming portion Y, a magenta (M) image forming portion M, a cyan (C) image forming portion C, and a black (K) image forming portion K. The printer engine 102 includes, in addition to the image forming portions Y, M, C, and K of the respective colors, primary transfer rollers 1408, 1409, 1410, and 1411, an intermediate transfer member 1412 serving as an image bearing member, a secondary transfer roller 1413, a fixing device 1414, a cleaner 1415, and the density detection sensor 2.

The image forming portions Y, M, C, and K of the respective colors include photosensitive drums 1401, 1402, 1403, and 1404 serving as photosensitive members, respectively. A yellow image is formed on the photosensitive drum 1401. A magenta image is formed on the photosensitive drum 1402. A cyan image is formed on the photosensitive drum 1403. A black image is formed on the photosensitive drum 1404. The primary transfer rollers 1408, 1409, 1410, and 1411 are arranged so as to correspond to the photosensitive drums 1401, 1402, 1403, and 1404, respectively. The intermediate transfer member 1412 is an endless belt member, which is wound around the secondary transfer roller 1413 to pass through portions between the photosensitive drums 1401, 1402, 1403, and 1404 and the primary transfer rollers 1408, 1409, 1410, and 1411, and is configured to rotate clockwise in FIG. 5.

The primary transfer rollers 1408, 1409, 1410, and 1411 are configured to transfer the images formed on the photosensitive drums 1401, 1402, 1403, and 1404 onto the intermediate transfer member 1412. The photosensitive drum 1401, the photosensitive drum 1402, the photosensitive drum 1403, and the photosensitive drum 1404 are arranged in order from the upstream side in a rotation direction of the intermediate transfer member 1412. The yellow image formed on the photosensitive drum 1401 is transferred onto the intermediate transfer member 1412 at a primary transfer nip portion formed between the photosensitive drum 1401 and the intermediate transfer member 1412. Similarly, the magenta image formed on the photosensitive drum 1402 is transferred onto the intermediate transfer member 1412 at a primary transfer nip portion formed between the photosensitive drum 1402 and the intermediate transfer member 1412. The cyan image formed on the photosensitive drum 1403 is transferred onto the intermediate transfer member 1412 at a primary transfer nip portion formed between the photosensitive drum 1403 and the intermediate transfer member 1412. The black image formed on the photosensitive drum 1404 is transferred onto the intermediate transfer member 1412 at a primary transfer nip portion formed between the photosensitive drum 1404 and the intermediate transfer member 1412. As described above, the images formed on the photosensitive drums 1401 to 1404 are transferred onto the intermediate transfer member 1412 in order from the photosensitive drum on the upstream side. The images transferred onto the intermediate transfer member 1412 are conveyed to the secondary transfer roller 1413 through rotation of the intermediate transfer member 1412. The secondary transfer roller 1413 is configured to transfer the images formed on the intermediate transfer member 1412 onto a recording medium between the secondary transfer roller 1413 and an opposing roller. The recording medium having the images transferred thereon is conveyed to the fixing device 1414. The fixing device 1414 is configured to fix the transferred images onto the recording medium. With this, the image formation onto the recording medium is ended. Developer remaining on the intermediate transfer member 1412 that has passed through the secondary transfer roller 1413 is removed by the cleaner 1415. The density detection sensor 2 is configured to detect the image density of the image formed on the intermediate transfer member 1412. Therefore, the density detection sensor 2 is arranged so that a detection portion (measurement position) is provided on the downstream side in the rotation direction of the intermediate transfer member 1412 as viewed from the image forming portions Y, M, C, and K.

The image forming portions Y, M, C, and K differ only in color of the image to be formed, and have the same configuration. Description is given here of the configuration of the yellow image forming portion Y, and description of the configurations of the image forming portions M, C, and K of the other colors is omitted.

The image forming portion Y includes the photosensitive drum 1401 serving as the image bearing member, a charging roller 1405, an exposing device 1406, and a developing device 1416. The photosensitive drum 1401 is configured to rotate in the arrow direction of FIG. 5. The charging roller 1405 is configured to uniformly charge the surface of the rotating photosensitive drum 1401. The exposing device 1406 is driven based on the drive signal acquired from the Y laser drive unit 1212 to irradiate the charged surface of the photosensitive drum 1401 with laser light. In this manner, an electrostatic latent image corresponding to the yellow image data is formed on the surface of the photosensitive drum 1401. The developing device 1416 is configured to develop the electrostatic latent image with yellow developer to form an image on the photosensitive drum 1401.

The developing device 1416 accommodates developer (two-component developer) in which toner particles (toner) and magnetic carrier particles (carrier) are mixed. The developing device 1416 includes a screw A 1420, a screw B 1421, a developing sleeve 1422, and a container 1407. The screw A 1420 and the screw B 1421 are configured to carry the toner particles in the developing device 1416 and mix the magnetic carrier particles with those toner particles, respectively. The developing sleeve 1422 is arranged close to the photosensitive drum 1401, and is rotated in accordance with the photosensitive drum 1401 to carry the developer in which the toner and the carrier are mixed. The developer carried by the developing sleeve 1422 is brought into contact with the photosensitive drum 1401, and thus the electrostatic latent image formed on the photosensitive drum 1401 is developed. The container 1407 is controlled by a Y toner replenishment control unit 1204 to replenish the developing device 1416 with the yellow toner.

Similarly, the container of the image forming portion M is controlled by an M toner replenishment control unit 1205 to replenish the developing device with the magenta toner. The container of the image forming portion C is controlled by a C toner replenishment control unit 1206 to replenish the developing device with the cyan toner. The container of the image forming portion K is controlled by a K toner replenishment control unit 1207 to replenish the developing device with the black toner.

### Density Detection Sensor

FIG. 6 is a configuration diagram of the density detection sensor 2. The density detection sensor 2 includes a light emitting portion 2c, light receiving portions 2e, 2f, and 2g, and prisms 2h and 2i. The light emitting portion 2c includes, for example, a light emitting diode (LED) configured to radiate near-infrared light as a light emitting element. Each of the light receiving portions 2e, 2f, and 2g includes, for example, a photodiode as a light receiving element. The density detection sensor 2 irradiates the surface (base surface) of the intermediate transfer member 1412 on which an image is to be formed with light by the light emitting portion 2c, and receives the reflective light by the light receiving portions 2f and 2g. The density detection sensor 2 detects the density of the base surface (base surface density) of the intermediate transfer member 1412 and the image density of the image formed on the intermediate transfer member 1412 based on the received reflective light. The light receiving portion 2e directly receives the light radiated from the light emitting portion 2c to detect an irradiation light amount. The irradiation light amount is used for controlling power to be supplied to the light emitting portion 2c.

The processing of detecting (processing of measuring) the image density, which is performed by the density detection sensor 2, is described. The irradiation light emitted by the light emitting portion 2c is separated by the prism 2h into a component (s-wave light) oscillating in a direction perpendicular to an incident surface and a component (p-wave light) oscillating in a direction parallel to the incident surface. The s-wave light enters the photodiode 2e, and the p-wave light irradiates the intermediate transfer member 1412. For example, the p-wave light irradiating the base surface part of the intermediate transfer member 1412 is substantially specularly reflected so as to pass through the prism 2i as the p-wave, that is, specularly reflected light, and is received by the light receiving portion 2f. The p-wave light irradiating the image on the intermediate transfer member 1412 is diffusely reflected to become the s-wave and the p-wave. The p-wave that has passed through the prism 2i is received by the light receiving portion 2f as specularly reflected light, and the s-wave is received by the light receiving portion 2g as the diffusely reflected light.

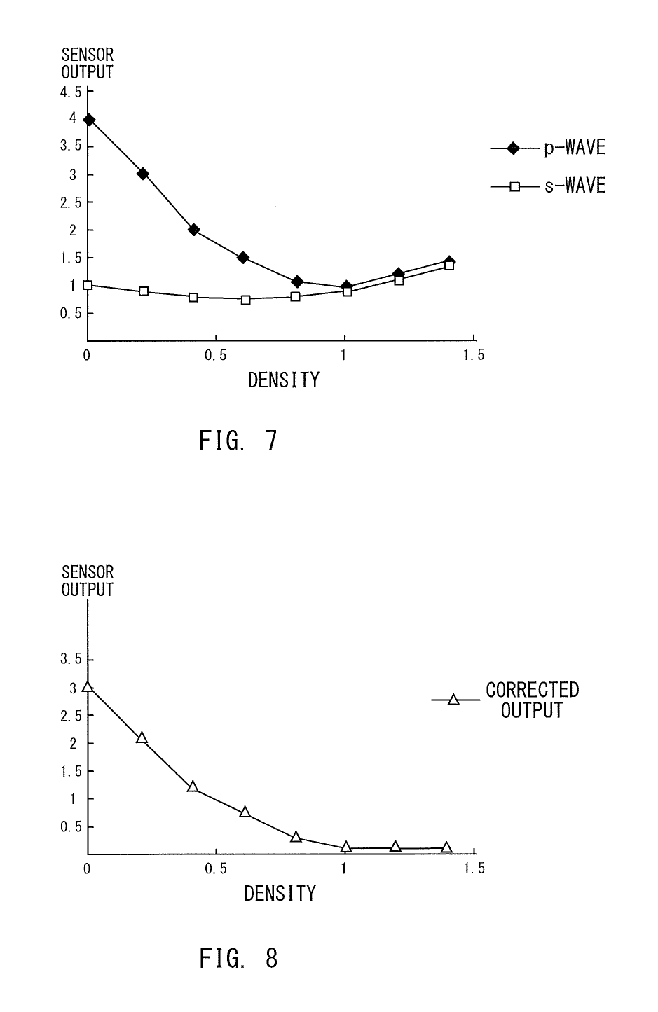

FIG. 7 is a graph for showing output values of the light receiving portions 2f and 2g in accordance with the light receiving amount with respect to the image density when the image on the intermediate transfer member 1412 (measurement image for image density detection) is irradiated with a certain amount of light. In FIG. 7, when the image density exceeds “1”, the output of the light receiving portion 2f receiving the p-wave, that is, the specularly reflected light is increased in accordance with the increase of the image density. Thus, it is considered that the light receiving portion 2f also receives the component of the diffusely reflected light. Therefore, when a product of the output of the light receiving portion 2g and a predetermined correction coefficient (k) is subtracted from the output of the light receiving portion 2f, that is, based on Expression 1, the true output (corrected output R) of the specularly reflected light can be obtained as shown in FIG. 8.

Corrected output R=(p-wave output (output of light receiving portion 2f))−(s-wave output (output of light receiving portion 2g))*(correction coefficient (k)) (Expression 1)

The output of the specularly reflected light (corrected output R) is known to change depending on the state of the base surface (surface of the intermediate transfer member 1412) when the image density is detected. The influence of the base surface is described.

The surface state of the intermediate transfer member 1412 changes as the image formation is performed. That is, the surface of the intermediate transfer member 1412 is scraped by rubbing and abutment of the cleaner 1415 and the photosensitive drums 1401, 1402, 1403, and 1404, and thus irregularities are formed. Further, toner flying in the apparatus may be adhered onto the surface of the intermediate transfer member 1412. Such a change in surface state of the intermediate transfer member 1412 causes change in amount of light reflected from the measurement image. Therefore, the density detection sensor 2 may have difficulty in accurately detecting the image density of the measurement image due to the change in surface state of the intermediate transfer member 1412. Further, when the surface of the intermediate transfer member 1412 is cleaned by the cleaner 1415, not all of the toner is removed. The unremoved toner is gradually accumulated to cause change in color of the surface of the intermediate transfer member 1412. Thus, the reflectance is reduced. As described above, the detection result (measurement result) of the image density detected by the density detection sensor 2 changes depending on the reflectance of the position (base surface) at which the image is formed (reflectance with respect to light used when the image density is detected), and hence the measured density value also changes over time.

Regarding such variation in reflectance of the base surface, the density detection sensor 2 simultaneously measures image densities of two points, that is, the base surface and the measurement image with use of the diffusely reflected component and the specularly reflected component, to thereby detect the image density of the measurement image based on a relative density. Thus, the density detection sensor 2 can measure the accurate image density of the measurement image. This processing is referred to as “base surface correction processing”.

For example, a detection result R_PCH′ of the specularly reflected light of the measurement image, which is subjected to base surface correction processing, is represented by Expression 2 with use of a correction coefficient α set in advance. “R_PCH” represents the corrected output R obtained by Expression 1 with respect to the detection result of the measurement image. “R_Base” represents the corrected output R obtained by Expression 1 with respect to the detection result of the base surface at a position at which the measurement image is formed.

R_PCH′=R_PCH*α/R_Base (Expression 2)

The detection result R_PCH′ calculated by Expression 2 is converted into a density value based on a predetermined density conversion table. FIG. 8 is an explanatory graph of such a density conversion table.

The intermediate transfer member 1412 has a home position (HP) mark (not shown) formed on its inner surface (surface on which an image is not formed). The HP mark is detected by an HP detection sensor (not shown) every time the intermediate transfer member 1412 rotates one revolution. With this, the measurement image can be formed at a position of the base surface at which the density has been detected. Further, even when the circumferential length of the intermediate transfer member 1412 changes, the position of the measurement image and the position of the base surface can be matched through detection of the HP mark.

Description is given of the processing of detecting the image density of the measurement image by the base surface correction processing. This processing is performed at the time of warm-up of the image forming apparatus 100, at a predetermined time interval, or every predetermined number of times of printing processing.

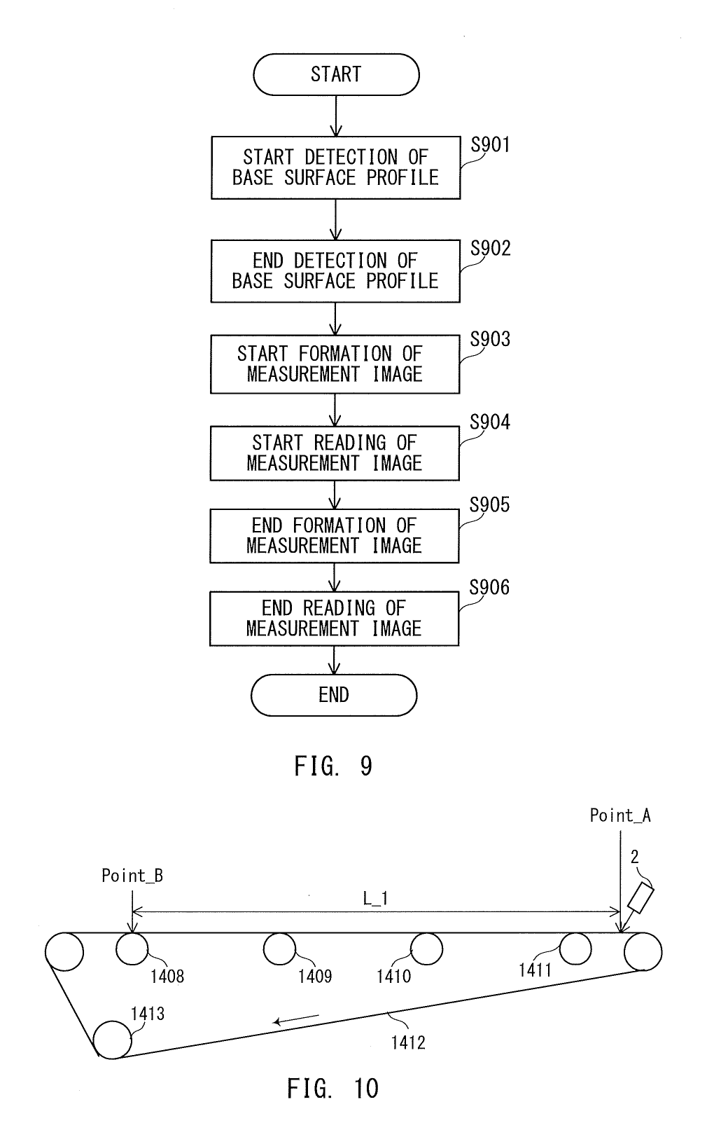

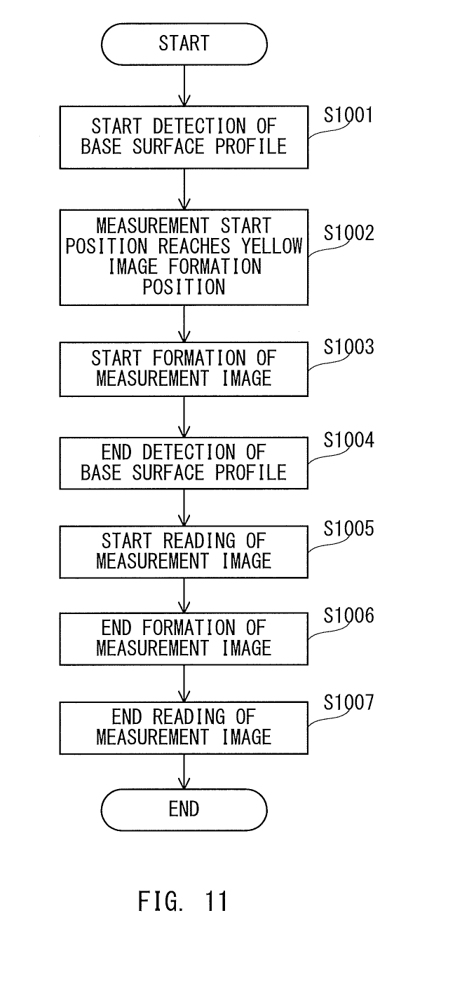

FIG. 9 is a flow chart for illustrating the processing of detecting the image density of the measurement image by related-art base surface correction processing. FIG. 10 is an explanatory diagram of this processing.

The printer image processing unit 119 starts detecting abase surface profile of the intermediate transfer member 1412 based on the detection result of the base surface density at the detection position (Point_A) of the density detection sensor 2 (Step S901). The base surface profile refers to measurement data generated based on the detection result (measurement result) of the base surface density of the surface of the intermediate transfer member 1412. The printer image processing unit 119 ends the detection of the base surface profile at a time point at which the intermediate transfer member 1412 rotates one revolution so that the density detection sensor 2 detects the base surface density at the same position again (Step S902). When the circumferential length (L_0) of the intermediate transfer member 1412 is 1,150 mm and the process speed (rotation speed of the intermediate transfer member 1412: PS) is 280 mm/s, the time required for the intermediate transfer member 1412 to rotate one revolution is 4.1 seconds. The printer image processing unit 119 detects the base surface profile for this time period to detect the image density of the base surface (base surface profile) of the intermediate transfer member 1412 for one turn.

The printer image processing unit 119 starts forming the measurement images for calibration in order from a position (image formation position (Point_B)) at which an image is transferred by the image forming portion Y located at the most upstream position in the rotation direction of the intermediate transfer member 1412 (Step S903). The measurement images are formed in order from the image forming portion Y to the image forming portion M, the image forming portion C, and the image forming portion K. The procedure of forming the measurement image is the same as the procedure of the normal image formation. Therefore, the measurement images are formed in order from the image forming portion Y located at the most upstream position in the rotation direction. This operation is employed because, when the image is formed in a procedure different from the procedure of the normal image formation, a fog toner amount of the image forming portion on the upstream side in the rotation direction and the surface potential of the intermediate transfer member 1412 may vary, and thus the image forming condition may change between during the normal image formation and during the measurement image formation.

When the measurement image is conveyed by a distance (L_1) from the image formation position (Point_B) of the image forming portion Y to the detection position (Point_A), the printer image processing unit 119 starts reading the measurement image by the density detection sensor 2 (Step S904). The distance (L_1) is, for example, 460 mm. Therefore, the time required for the measurement image to be conveyed from the image formation position (Point_B) to the detection position (Point_A) is 1.6 seconds. The printer image processing unit 119 starts reading the measurement image by the density detection sensor 2 after an elapse of 1.6 seconds from the image formation by the image forming portion Y. After all of the image forming portions Y, M, C, and K end formation of the measurement images (Step S905), the printer image processing unit 119 ends the reading of the measurement image by the density detection sensor 2 after an elapse of a predetermined time period (Step S906). The predetermined time period is determined based on the process speed and the distance from the image formation position of the image forming portion K to the detection position (Point_A).

The measurement image is, for example, an image having a length in the rotation direction of the intermediate transfer member 1412 of 22.8 mm and 10 grayscales. The four-color YMCK measurement images have a length (L_2) in the rotation direction of the intermediate transfer member 1412 of 912 mm. In this case, 3.3 seconds are required from the processing of Step S904 to the processing of Step S906.

As described above, hitherto, the formation of the measurement image by the image forming portion Y is started after the measurement start position of the base surface density for base surface profile formation is rotated one revolution due to the rotation of the intermediate transfer member 1412 to reach the detection position (Point_A) of the density detection sensor 2. Therefore, time is required for the measurement image to be conveyed by the distance (L_1) from the image formation position (Point_B) of the image forming portion Y to the detection position (Point_A) of the density detection sensor 2.

FIG. 11 is a flow chart for illustrating the processing of detecting the image density of the measurement image by the base surface correction processing of the first embodiment.

The printer image processing unit 119 starts detecting abase surface profile of the intermediate transfer member 1412 based on the detection result of the base surface density at the detection position (Point_A) of the density detection sensor 2 (Step S1001). The base surface profile refers to measurement data generated based on the detection result (measurement result) of the base surface density of the surface of the intermediate transfer member 1412. The printer image processing unit 119 detects that the measurement start position of the base surface profile has reached the image formation position (Point_B) of the image forming portion Y due to the rotation of the intermediate transfer member 1412 (Step S1002). The intermediate transfer member 1412 is rotationally driven by a distance (690 mm=L_0−L_1) obtained by subtracting the distance (L_1) between the detection position (Point_A) of the density detection sensor 2 and the image formation position (Point_B) of the image forming portion Y from the circumferential length (L_0). The printer image processing unit 119 detects that the intermediate transfer member 1412 has been rotationally driven by this distance, to thereby detect that the measurement start position has reached the image formation position (Point_B) of the image forming portion Y. The printer image processing unit 119 starts forming the measurement image in accordance with, for example, an elapse of a predetermined time period from the start of the detection of the base surface profile. At this time, the predetermined time period corresponds to the time required for the intermediate transfer member 1412 to rotate by the above-mentioned distance. The predetermined time period may be stored in, for example, the ROM 107 in advance.

Immediately after the printer image processing unit 119 detects that the measurement start position of the base surface profile has reached the image formation position (Point_B) of the image forming portion Y, the printer image processing unit 119 starts forming the measurement images for calibration in order from the image forming portion Y (Step S1003). The measurement images are formed in order from the image forming portion Y to the image forming portion M, the image forming portion C, and the image forming portion K. The time required from the processing of Step S1002 to the processing of Step S1003 can be sufficiently reduced because it is only required to prevent the toner from flying toward the measurement start position of the base surface profile, for example.

The printer image processing unit 119 ends the detection of the base surface profile at a time point at which the intermediate transfer member 1412 rotates one revolution so that the measurement start position of the base surface profile reaches the detection position (Point_A) of the density detection sensor 2 (Step S1004). At this time point, the generation of the base surface profile is ended. When the circumferential length (L_0) of the intermediate transfer member 1412 is 1,150 mm and the process speed (rotation speed of the intermediate transfer member 1412: PS) is 280 mm/s, the time required for the intermediate transfer member 1412 to rotate one revolution is 4.1 seconds. The printer image processing unit 119 detects the base surface profile for this time period to detect the image density of the base surface of the intermediate transfer member 1412 for one turn. The measurement period refers to a period in which, in order to detect the base surface profile, the density detection sensor 2 irradiates the intermediate transfer member 1412 with light and the intermediate transfer member 1412 rotates one turn.

When the measurement image is conveyed by the distance (L_1) from the image formation position (Point_B) of the image forming portion Y to the detection position (Point_A), the printer image processing unit 119 starts reading the measurement image by the density detection sensor 2 (Step S1005). The formation of the measurement image is started immediately after the processing of Step S1002, and hence the printer image processing unit 119 can start reading the measurement image immediately after the processing of Step S1004. The printer image processing unit 119 ends the formation of the measurement image (Step S1006), and immediately after that, ends the reading of the measurement image by the density detection sensor 2 (Step S1007). The time required from the processing of Step S1006 to the processing of Step S1007 is, similarly to the time required from the processing of Step S904 to the processing of Step S905 of FIG. 9, 3.3 seconds because the length (L_2) of the measurement images in the rotation direction of the intermediate transfer member 1412 is 912 mm.

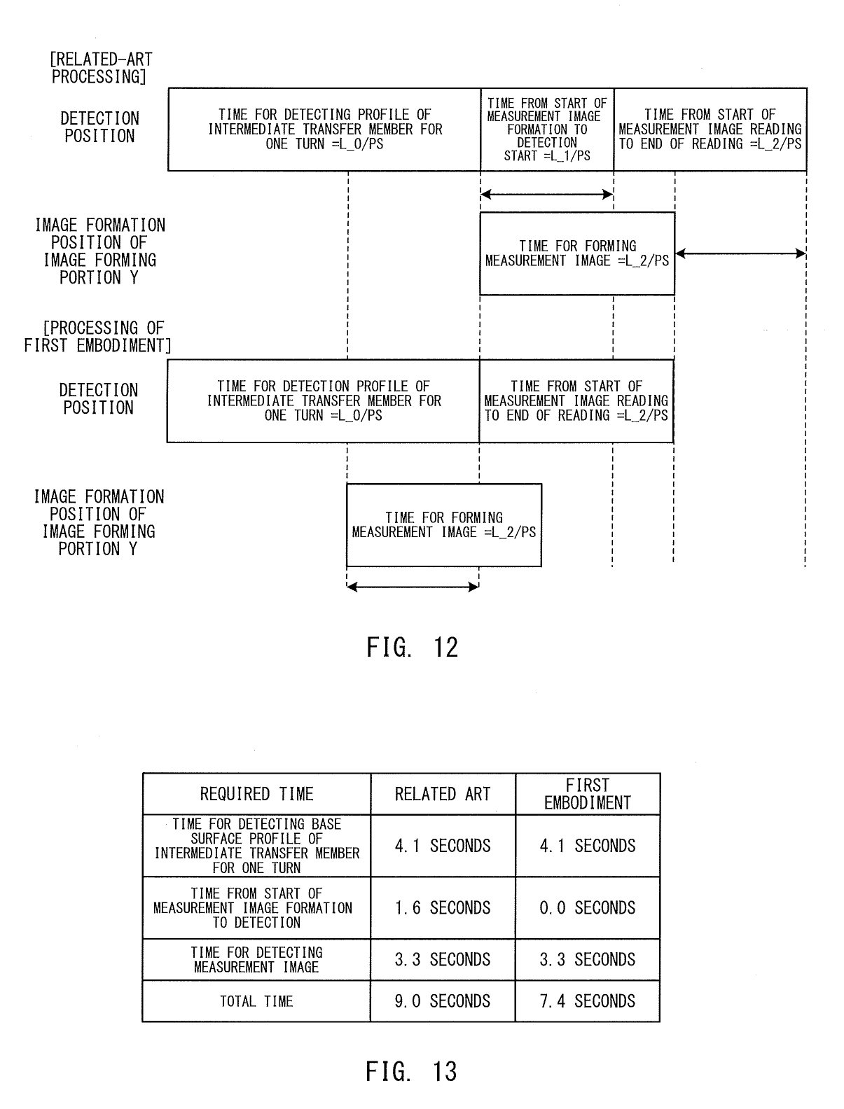

FIG. 12 is a timing chart of the processing of detecting the image density of the measurement image by the base surface correction processing described above. In FIG. 12, the timing chart of the related-art processing and the timing chart of the processing of the first embodiment are compared.

In the related-art processing, the formation of the measurement image is started after the intermediate transfer member 1412 is rotated one revolution and the detection of the base surface profile is ended. Therefore, as described above, extra time is required for conveying the measurement image by the distance (L_1) from the image formation position (Point_B) of the image forming portion Y located at the most upstream position in the rotation direction of the intermediate transfer member 1412 to the detection position (Point_A) of the density detection sensor 2.

In the processing of the first embodiment, the formation of the measurement image is started at a timing immediately after the measurement start position at which the base surface profile is first detected reaches the image formation position (Point_B) of the image forming portion Y without waiting for the detection of the base surface profile of the intermediate transfer member 1412 for one turn. Therefore, the measurement image can be detected immediately after the base surface profile of the intermediate transfer member 1412 is detected for one turn. Thus, the base surface profile and the measurement image can be detected in a shorter time period as compared to that in the related-art processing.

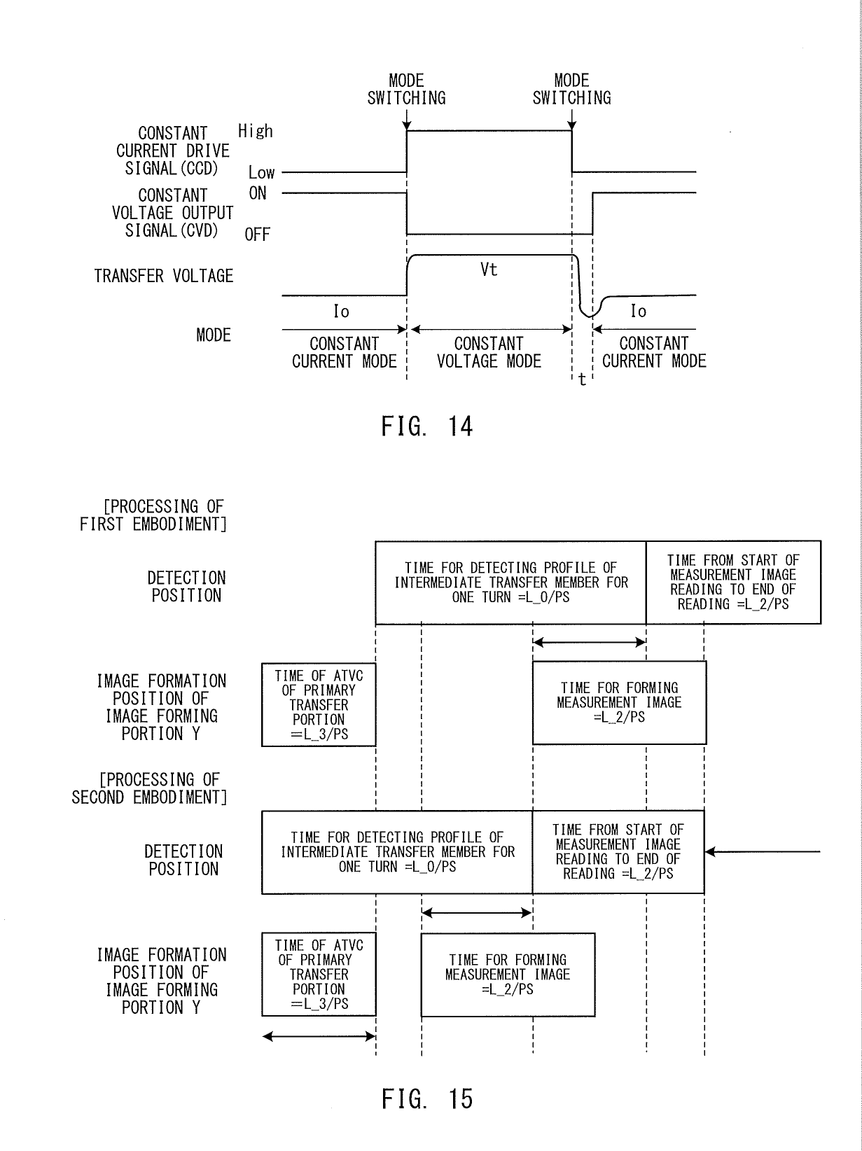

FIG. 13 is a table of the time required for each step. The formation of the measurement image is started while the base surface profile of the intermediate transfer member 1412 is detected, and hence the total time required for the processing can be reduced. In the example of FIG. 13, no time is required from the start of measurement image formation to the detection, and hence the time required for the processing is 7.4 seconds, which is reduced by 1.6 seconds from 9.0 seconds of the related art. This reduction in time is directly linked to reduction in time required from the activation start to the warm-up end of the image forming apparatus 100.

The image forming apparatus 100 measures the image density of the measurement image based on the detection result of the measurement image, and performs calibration of the image forming condition based on the detection result (measurement result). The image forming condition includes the exposure amount of the exposing device 1406, the developing bias of the developing device 1416, the γ correction table, the process condition, and the correction condition for correcting the grayscale of the image. The time required from the activation start to the warm-up end of the image forming apparatus 100 is reduced, and hence the time required for the calibration of the image forming condition is reduced. Further, with the calibration of the image forming condition, the quality of the image to be formed can be ensured.

### Second Embodiment

In a second embodiment of the present invention, at a timing before the measurement start position on the intermediate transfer member 1412 at which detection of the base surface profile is started reaches the image formation position of the image forming portion Y, the image forming apparatus 100 performs transfer control to be described later. When the calibration of the image forming condition is started after a transfer condition is adjusted by the transfer control, the time required from the activation start to the warm-up end can be reduced. The configuration of the image forming apparatus 100 is similar to that of the first embodiment, and hence description thereof is omitted herein.

### Transfer Control

The transfer of the images from the photosensitive drums 1401 to 1404 onto the intermediate transfer member 1412 is performed by a contact transfer system. In the contact transfer system, the images are transferred by a transfer voltage applied to the primary transfer rollers 1408 to 1411. The characteristics of the primary transfer rollers 1408 to 1411 change depending on the environmental change or other factors. In the contact transfer system, the change in characteristics of the primary transfer rollers 1408 to 1411 affects the image transfer. Therefore, the transfer voltage to be applied to the primary transfer rollers 1408 to 1411 is required to be controlled as appropriate in accordance with the change in characteristics of the primary transfer rollers 1408 to 1411.

As a system of controlling the transfer voltage, there is known automatic transfer voltage control (ATVC), for example. In the ATVC, at a timing at which an image is not formed on the intermediate transfer member 1412, an application voltage Vto applied when a current flowing through the primary transfer rollers 1408 to 1411 becomes a constant current value Io set in advance is detected (constant current mode). A transfer voltage Vt is determined based on this application voltage Vto. The transfer voltage Vt is determined by Expression 3, for example. When an image is formed on the intermediate transfer member 1412, the primary transfer rollers 1408 to 1411 are applied with the transfer voltage Vt determined by Expression 3 to transfer the images (constant voltage mode).

[kV] (Expression 3)

When the transfer voltage Vt is determined as described above, even in a case where the characteristics of the primary transfer rollers 1408 to 1411 change due to the environmental change or other factors, the transfer voltage Vt maybe adjusted in accordance with the characteristic conversion to enable satisfactory image transfer.

The timing at which the image is not formed on the intermediate transfer member 1412 refers to a timing from the reception of the print job to the formation of the image to be formed on the first recording medium on the intermediate transfer member 1412, or a timing between pages when image formation is successively performed.

A voltage generation unit configured to generate the transfer voltage Vt is controlled by two signals, that is, a constant voltage output signal (CVD) and a constant current drive signal (CCD) output from the printer image processing unit 119. The constant voltage output signal (CVD) is an analog control signal for controlling the output level of the transfer voltage Vt in the constant voltage mode. The constant current drive signal (CCD) is a control signal used in a case of drive with the constant current mode in which the constant current Io set in advance is caused to flow through the primary transfer rollers 1408 to 1411. The constant current mode is set when the constant current drive signal (CCD) is at a Low level. The application voltage Vto during constant current is detected by an analog signal (voltage detection signal (VSEN)) for detecting the application voltage.

FIG. 14 is a timing chart of mode switching between the constant current mode and the constant voltage mode in the voltage generation unit configured to generate the transfer voltage Vt. This timing chart represents timings of the constant voltage output signal (CVD) and the constant current drive signal (CCD) input to the voltage generation unit, and the transfer voltage Vt output from the voltage generation unit.

In the constant current mode, the constant voltage output signal (CVD) is turned “on”, and the constant current drive signal (CCD) becomes “Low”, and thus the ATVC is performed. That is, the voltage generation unit is controlled so that the current flowing through the primary transfer rollers 1408 to 1411 becomes a predetermined constant current value Io. In this manner, the application voltage Vto is detected. The transfer voltage Vt is determined (calculated) by Expression 3 based on the application voltage Vto.

The mode switching from the constant current mode to the constant voltage mode is performed by setting the constant current drive signal (CCD) to “High”, that is, setting the constant current mode control to an off state, and dropping the constant voltage output signal (CVD) to a predetermined voltage so as to turn off the constant voltage output signal (CVD). When the mode is switched to the constant voltage mode, the transfer voltage Vt determined during the constant current mode is applied from the voltage generation unit to the primary transfer rollers 1408 to 1411.

The mode switching from the constant voltage mode to the constant current mode is performed by setting the constant current drive signal (CCD) to “Low” and turning on the constant voltage output signal (CVD). In this manner, the voltage generation unit is controlled again so that the current flowing through the primary transfer rollers 1408 to 1411 becomes the constant current value Io, and thus the application voltage Vto is detected. The transfer voltage Vt is determined (calculated) by Expression 3 based on the newly detected application voltage Vto.

In the second embodiment, the time required for the ATVC of the primary transfer rollers 1408 to 1411 is 2.2 seconds. When the process speed being the rotation speed of the intermediate transfer member 1412 is 280 mm/s, the intermediate transfer member 1412 rotates by 616 mm during the ATVC.

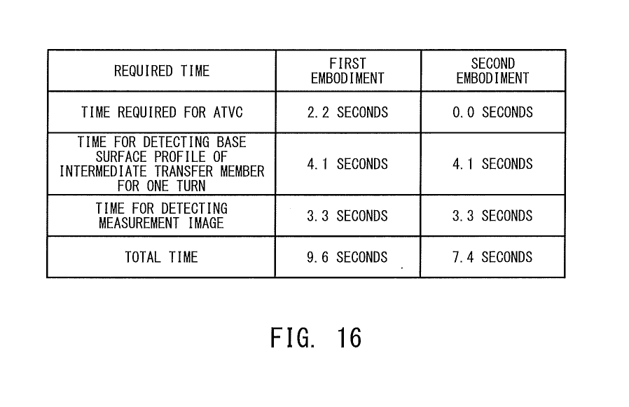

Also in the second embodiment, the processing of detecting the image density of the measurement image by the base surface correction processing is performed based on the flow chart of FIG. 11. FIG. 15 is a timing chart of the processing of detecting the image density of the measurement image by the base surface correction processing including the ATVC. In FIG. 15, the timing chart of the first embodiment and the timing chart of the second embodiment are compared. In the first embodiment, the ATVC of the primary transfer rollers 1408 to 1411 and the detection of the base surface profile of the intermediate transfer member 1412 for one turn are executed in different sequences. In the second embodiment, the ATVC of the primary transfer rollers 1408 to 1411 and the detection of the base surface profile of the intermediate transfer member 1412 for one turn are executed in parallel.

In this case, the distance in which the measurement start position of the base surface profile of the intermediate transfer member 1412 moves to the image formation position (Point_B) of the image forming portion Y located at the most upstream position in the rotation direction of the intermediate transfer member 1412 is 690 mm as described in the first embodiment. This distance is longer than 616 mm, which is a distance by which the intermediate transfer member 1412 rotates during the ATVC of the primary transfer rollers 1408 to 1411. Therefore, the detection of the base surface profile can be executed in parallel to the ATVC.

FIG. 16 is a table of the time required for each step. The processing of the ATVC is executed in parallel to the detection of the base surface profile, and hence the time (7.4 seconds) of the processing of the second embodiment is shorter than the time (9.6 seconds) of the processing of the first embodiment by the time (2.2 seconds) required for the ATVC. In the example of FIG. 13, the time required for the processing is 7.4 seconds, which is reduced by 1.6 seconds from 9.0 seconds of the first embodiment. This reduction in time is directly linked to reduction in time required from the activation start to the warm-up end of the image forming apparatus 100.

The image forming apparatus 100 measures the image density of the measurement image based on the detection result of the measurement image, and performs calibration of the image forming condition based on the detection result (measurement result). The image forming condition includes the exposure amount of the exposing device 1406, the developing bias of the developing device 1416, the y correction table, the process condition, and the correction condition for correcting the grayscale of the image. The time required from the activation start to the warm-up end of the image forming apparatus 100 is reduced, and hence the time required for the calibration of the image forming condition is reduced. That is, the formation of the measurement image is started before the intermediate transfer member rotates one revolution during the calibration of the image forming condition. Thus, the standby time before the start of the formation of the measurement image can be reduced, and the time required for the calibration can be reduced. Further, the quality of the image to be formed can be ensured due to the calibration of the image forming condition. Further, the quality of the image is further improved by performing the ATVC for the transfer voltage, which is one example of the image forming condition.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions. Further, Embodiment(s) of the present invention can also be realized by a computer of a system or apparatus that includes one or more circuits (e.g., application specific integrated circuit (ASIC) or SOC (system on a chip)) for performing the functions of one or more of the above-described embodiment(s).

This application claims the benefit of Japanese Patent Application No. 2016-219920, filed Nov. 10, 2016 which is hereby incorporated by reference herein in its entirety.

What is claimed is:

1. An image forming apparatus, comprising:
an image forming unit configured to form an image;
an intermediate transfer member configured to rotate;
a transfer unit configured to transfer a measurement image formed by the image forming unit onto the intermediate transfer member;
a measurement unit configured to measure the measurement image transferred onto the intermediate transfer member; and
a controller configured to:
control the image forming unit to form the measurement image;
control the transfer unit to transfer the measurement image onto the intermediate transfer member;
control the measurement unit to measure the measurement image; and
control an image forming condition based on measurement data corresponding to a measurement result of the measurement image measured by the measurement unit and profile data relating to the intermediate transfer member,
wherein the controller controls, while the intermediate transfer member rotates, the measurement unit to measure the intermediate transfer member, and generates the profile data based on a measurement result of the intermediate transfer member for single turn, and
wherein the controller controls the image forming unit to start forming the measurement image before the measurement of the intermediate transfer member for single turn is ended.

2. The image forming apparatus according to claim 1, wherein, before a position on the intermediate transfer member, at which the measurement unit starts measuring the intermediate transfer member in order to generate the profile data, reaches a measurement region of the measurement unit again, the transfer unit transfers the measurement image onto the intermediate transfer member.

3. The image forming apparatus according to claim 2, wherein, after the position passes through a transfer nip for transferring the measurement image onto the intermediate transfer member, the transfer unit transfers the measurement image onto the intermediate transfer member.

4. The image forming apparatus according to claim 3,
wherein the intermediate transfer member has a plurality of transfer nips formed thereon along a direction in which the intermediate transfer member rotates, the plurality of transfer nips being configured to transfer images of different colors, and
wherein, after the position passes through a predetermined transfer nip among the plurality of transfer nips in the direction in which the intermediate transfer member rotates, the transfer unit transfers the measurement image onto the intermediate transfer member.

5. The image forming apparatus according to claim 4, wherein the predetermined transfer nip corresponds to a transfer nip that is farthest from the measurement region of the measurement unit.

6. The image forming apparatus according to claim 1, wherein the image forming condition comprises a process condition for adjusting a density of the image to be formed by the image forming unit.

7. The image forming apparatus according to claim 1, wherein the image forming condition comprises a correction condition for correcting a grayscale of the image to be formed by the image forming unit.

8. The image forming apparatus according to claim 1, wherein, when the controller controls the image forming condition successively after the profile data is generated, the controller controls the image forming unit to start forming the measurement image after an elapse of a predetermined time period from when the measurement unit starts measuring the intermediate transfer member.

9. The image forming apparatus according to claim 8, wherein the controller is configured to determine the predetermined time period based on a rotation speed of the intermediate transfer member.

10. The image forming apparatus according to claim 1, wherein the image forming unit comprises:
a photosensitive member;
an exposing device configured to expose the photosensitive member to form an electrostatic latent image; and
a developing device configured to develop the electrostatic latent image.

11. The image forming apparatus according to claim 1, wherein the measurement unit corresponds to a sensor configured to measure light reflected from the measurement image.
